(19) United States
(12) Patent Application Publication
(10) Pub. No.: US 2016/0365920 A1
(43) Pub. Date: Dec. 15, 2016

(54) OPTICAL TRANSMISSION SYSTEM AND DELAY MEASUREMENT METHOD

(71) Applicant: MITSUBISHI ELECTRIC CORPORATION, Tokyo (JP)

(72) Inventors: Yuta TAKEMOTO, Tokyo (JP); Yoshiaki KONISHI, Tokyo (JP)

(73) Assignee: MITSUBISHI ELECTRIC CORPORATION, Chiyoda-ku (JP)

(21) Appl. No.: 15/118,280

(22) PCT Filed: Feb. 6, 2015
(86) PCT No.: PCT/JP15/00545

§ 371 Date: Aug. 11, 2016

(30) Foreign Application Priority Data
Feb. 26, 2014 (JP) 2014-034833

(51) Int. Cl. H04B 10/077; H04J 3/16; H04J 3/06

(52) U.S. Cl. CPC H04B 10/0775; H04J 3/0682; H04J 3/1652

(57) ABSTRACT

An optical transmission system includes: a first optical transmission device that transmits a first frame including a control signal; and a second optical transmission device that receives the first frame, inserts, into a control signal, phase information indicating a transmission position within a frame transmitted at a time at which the control signal of the first frame is received, and transmits a second frame including the control signal into which the phase information is inserted. The first optical transmission device receives the second frame and measures a transmission delay time between the first optical transmission device and the second optical transmission device on the basis of information indicating a time at which the control signal of the first frame is transmitted, information indicating a time at which the control signal of the second frame is received, and the phase information.

### FIELD

The present invention relates to an optical transmission system and a delay measurement method.

### BACKGROUND

MFH (Mobile Front-Haul) has been introduced as a form of a radio base station device. In MFH, optical interfaces, such as a CPRI (Common Public Radio Interface), are used to distribute RRHs (Remote Radio Heads) constructed from antennas and other components and cause the performance of the digital signal processing to be concentrated in a BBU (Base Band Unit).

In addition, there is a known technology for encapsulating and transmitting CPRI signals in an OTUk (Optical channel Transport Unit-k) frame defined in the ITU-T G. 709 standard (for example, see Non Patent Literature 1).

Further, there is a known delay measurement method that uses a DM (Delay Measurement) byte of overhead to measure the transmission delay time between optical transmission devices that transmit OTUk frames (for example, see Patent Literature 1).

### CITATION LIST

### Non Patent Literature

Non Patent Literature 1: Recommendation ITU-T G.709/Y.1331(12/2009), “Interfaces for the Optical Transport Network (OTN)”.

### Patent Literature

Patent Literature 1: Japanese Patent Application Laid-Open No. 2013-153367

### SUMMARY

### Technical Problem

In a CPRI, the RTT (Round Trip Time) corresponding to an allowed transmission delay time is about 100 us, which is short, and the accuracy of the RTT is defined as +/−16 ns, which is a strict value. However, for a transmission interval of CPRI signals, the RTT can be measured using a CPRI format.

Meanwhile, when CPRI signals are transmitted by being encapsulated in an OTUk frame, as disclosed in Non Patent. Literature 1, to increase the transmission distance of MFH, it is desirable to transparently transmit the CPRI signals without change in the middle of transmission, and it is also desirable that the RTT of the CPRI signals is measured between optical transmission devices in a transmission interval of the OTUk frame while the CPRI signals remain encapsulated in the OTUk frame.

However, in the conventional delay measurement method, which uses a DM byte and is disclosed in Patent Literature 1, the measurement accuracy is limited to an OTUk frame interval. Thus, the RTT cannot be measured in units of time of less than 12 usec at 10 Gb/s, and the RTT cannot be measured in units of time of less than 50 usec at 2.5 Gb/s. Therefore, there is a problem in that the measurement accuracy is insufficient with respect to the accuracy of the RTT defined in the CPRI signals described above.

The present invention has been conceived to solve the above-mentioned problem, and an object of the present invention is to achieve high accuracy of, for example, delay measurement by using a DM byte in, for example, an optical transmission system using an OTUk frame.

### SOLUTION TO PROBLEM

An optical transmission system according to an aspect of the present invention includes a first optical transmission device that transmits a first frame including a control signal; and a second optical transmission device that receives the first frame, inserts, into a control signal, phase information indicating a transmission position within a frame transmitted at a time at which the control signal of the first frame is received, and transmits a second frame including the control signal into which the phase information is inserted. The first optical transmission device receives the second frame and measures a transmission delay time between the first optical transmission device and the second optical transmission device on a basis of information indicating a time at which the control signal of the first frame is transmitted, information indicating a time at which the control signal of the second frame is received, and the phase information.

### ADVANTAGEOUS EFFECTS OF INVENTION

The present invention can measure a transmission delay time in units of time shorter than the length of one frame in an optical transmission system using a frame.

### BRIEF DESCRIPTION OF DRAWINGS

FIG. 1 is an explanatory diagram describing an optical transmission system according to a first embodiment of the present invention.

FIG. 2 is a block diagram illustrating an application example of the optical transmission system according to the first embodiment of the present invention.

FIG. 3 is an explanatory diagram describing the optical transmission system according to the first embodiment of the present invention.

FIG. 4 is a block diagram illustrating the optical transmission system according to the first embodiment of the present invention.

FIG. 5 is an explanatory diagram describing the optical transmission system according to the first embodiment of the present invention.

### DESCRIPTION OF EMBODIMENTS

### First Embodiment

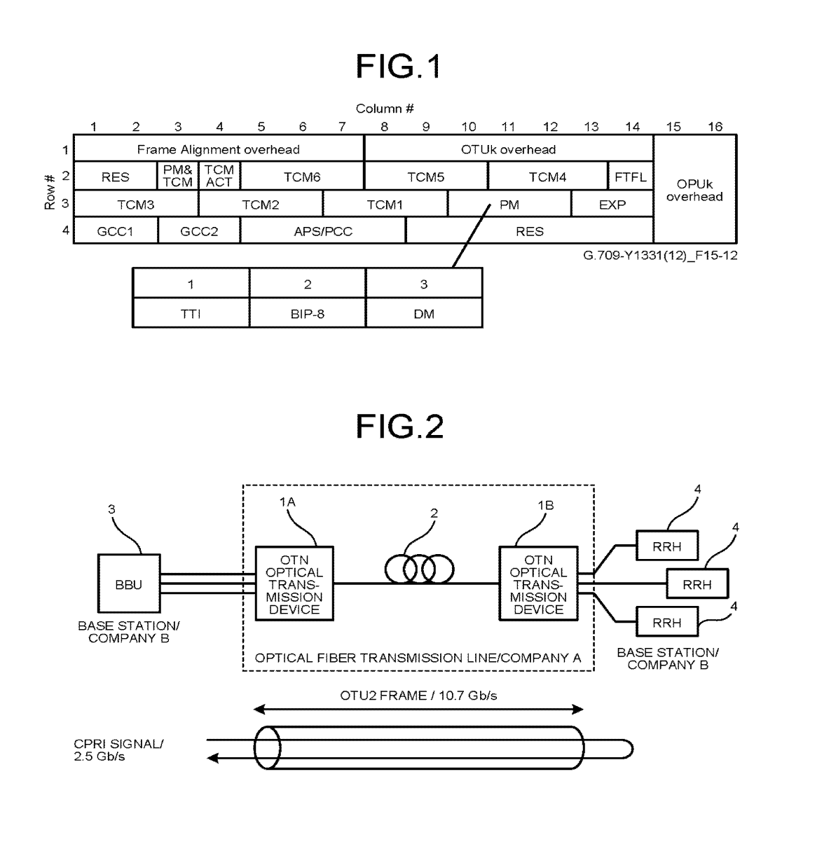

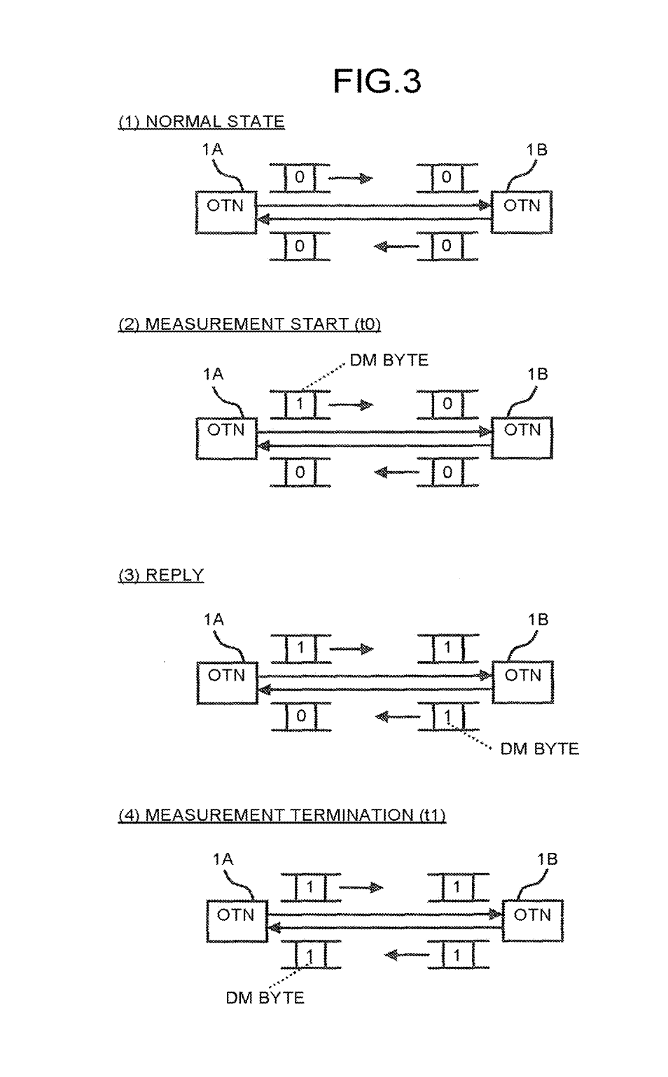

FIGS. 1 to 3 are explanatory diagrams describing an optical transmission system according to a first embodiment of the present invention. FIG. 1 illustrates a DM (Delay Measurement) byte in the overhead of an OTUk (Optical channel Transport Unit-k) frame defined in the ITU-T G.709/Y.1331 standard; FIG. 2 illustrates an example of MFH (Mobile Front-Haul) to which the optical transmission system is applied; and FIG. 3 illustrates the procedure of a conventional delay measurement method using a DM byte. In the respective figures, the same reference numeral indicates the same or a corresponding part.

As illustrated in FIGS. 1 and 2, in an OTU2 (Optical channel Transport Unit-2) frame corresponding to the transfer rate of 10.7 Gb/s, which is an example of an OTUk frame, the overhead for supervisory control including a DM byte as a control signal is added to payload data, in which user data is stored, by an OTN (Optical Transport Network) optical transmission device 1A serving as a first optical transmission device and is transmitted through an optical fiber transmission line 2; the overhead is removed by an OTN optical transmission device 1B serving as a second optical transmission device; and the user data is distributed. A CPRI (Common Public Radio Interface) signal corresponding to the transfer rate of 2.5 Gb/s, which is an example of the user data, is transmitted from a BBU (Base Band Unit) 3 and is received by, for example, three respective RRHs (Remote Radio Heads) 4.

As illustrated in FIG. 2, the OTN optical transmission device 1A, the OTN optical transmission device 1B, and the optical fiber transmission line 2 may be managed by a company A that conducts an optical communication business, and the BBU 2 and the RRHs 3, which are included in the base station, may be managed by another company B that conducts a radio communication business. In this instance, it is desirable for the company B, which manages the CPRI signals corresponding to user data from customers of the company B, that the company A, which provides the optical fiber transmission line 2 for transmitting the CPRI signals, transparently transmits the CPRI signals without change in the middle of transmission. Further, it is desirable for the company A to individually manage delay performance to provide a service to the company B. In addition, when a plurality of CPRI signals are multiplexed, some CPRI signals may be inserted and extracted. Thus, it is desirable to implement a delay measurement method using an OTUk frame rather than a delay measurement method that depends on a CPRI format.

In a conventional delay measurement method using an OTUk frame, the RTT (Round Trip Time) corresponding to the transmission delay time is measured in the procedure below using a DM byte in the overhead. This procedure is illustrated in FIGS. 3(1) to 3(4).

In the normal state illustrated in FIG. 3(1), the measurement-side OTN optical transmission device 1A and the return-side OTN optical transmission device 1B transmit 0 as a DM byte.

At the time of starting measurement (t0) illustrated in FIG. 3(2), the measurement-side OTN optical transmission device 1A sets 1 in a DM byte to be transmitted.

At the time of reply illustrated in FIG. 3(3), the OTN optical transmission device 1B that has received the DM byte in which 1 is set. sets 1 in a DM byte that the OTN optical transmission device 1B returns.

At the time of terminating measurement (t1) illustrated in FIG. 3(4), the OTN optical transmission device 1A calculates the RTT by subtracting the measurement start time t0 from the time t1 at which the DM byte in which 1 is set is received.

In this instance, the DM byte is allocated to a fixed position in an OTUk frame. For this reason, even when the OTN optical transmission device 1B receives the DM byte from the OTN optical transmission device 1A immediately before replying to the DM byte or immediately after replying to the DM byte in the previous frame, the DM byte is not transmitted until the time when a reply is to be made to a DM byte in the subsequent frame. Thus, the OTN optical transmission device 1B returns the DM byte to the OTN optical transmission device 1A at the same timing.

For this reason, the accuracy of delay measurement in this case is limited to being in units of an OTUk frame. The length of one frame is 12 usec at 10 Gb/s, and the length of one frame is 50 usec at 2.5 Gb/s. Thus, as described in the foregoing, the conventional delay measurement method using the DM byte is not useful for delay measurement for a CPRI interface.

Alternatively, in the delay measurement method of the optical transmission system according to the first embodiment of the present invention, the OTN optical transmission device 1B stores byte position information n within a transmission frame at a point in time at which the DM byte is received from the OTN optical transmission device 1A in the DM byte to be transmitted by the OTN optical transmission device 1B. In this way, as described below, it is possible to achieve high accuracy of delay measurement using a DM byte.

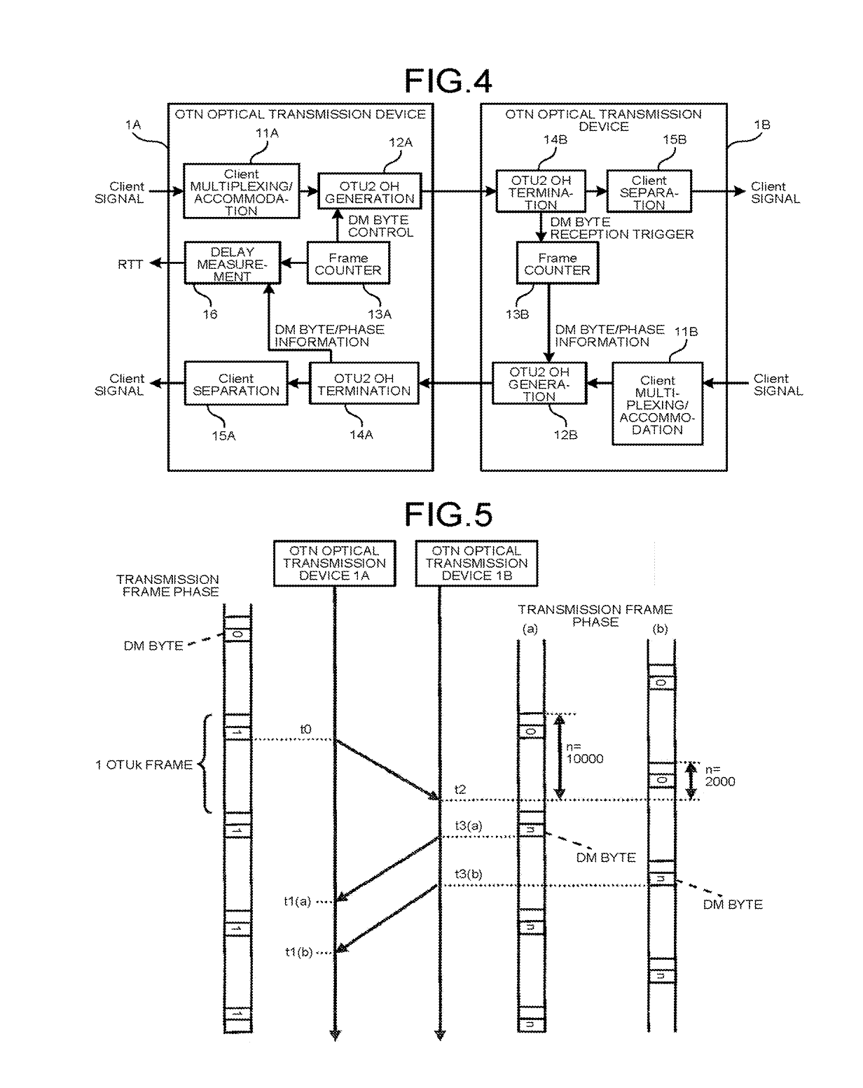

FIG. 4 is a block diagram illustrating the optical transmission system according to the first embodiment of the present invention. In the respective figures, the same reference numeral indicates the same or a corresponding part. As illustrated in FIG. 4, the OTN optical transmission device 1A includes a client multiplexing/accommodation unit 11A, an OTU2 OH (Optical channel Transport Unit-2 Overhead) generation unit 12A, a frame counter unit 13A, an OTU2 OH termination unit 14A, a client separation unit 15A, and a delay measurement unit 16, and an OTN optical transmission device 1B includes a client multiplexing/accommodation unit 11B, an OTU2 OH generation unit 12B, a frame counter unit 13B, an OTU2 OH termination unit 14B, and a client separation unit 15B.

In FIG. 4, when the optical transmission system according to the first embodiment of the present invention is applied to MFH illustrated in FIG. 2, a client signal corresponding to user data is a CPRI signal. The optical fiber transmission line 2 is not illustrated.

Next, an operation will be described. In FIG. 4, when the OTN optical transmission device 1A measures the RTT between the OTN optical transmission device 1A and the OTN optical transmission device 1B, the client multiplexing/accommodation unit 11A of the OTN optical transmission device 1A multiplexes client signals input to the OTN optical transmission device 1A and accommodates the client signals in payload data of an OTU2 frame or simply accommodates the client signals, and the OTU2 OH generation unit 12A adds an overhead to the payload data.

In this instance, the frame counter unit 13A writes 1, which is a flag bit indicating a measurement start, to a DM byte, and the OTU2 OH generation unit 12A transmits, to the OTN optical transmission device 1B, an OTU2 frame serving as a first frame to which an overhead including the DM byte is added as, for example, an optical signal in a wavelength range of 1.5 um. That is, the OTN optical transmission device 1A encapsulates the client signals in the OTU2 frame and then transmits the OTU2 frame to the OTN optical transmission device 1B. In addition, the frame counter unit 13A starts a counter simultaneously with transmitting the DM byte in which the flag bit is set.

Subsequently, in FIG. 4, the OTU2 OH termination unit 14B of the OTN optical transmission device 1B receives the OTU2 frame from the OTN optical transmission device 1A and then terminates the overhead including the DM byte. That is, the OTU2 OH termination unit 14B sends the overhead to the frame counter unit 13B and sends a frame from which the overhead is removed to the client separation unit 15B. The client separation unit 15B separates the client signals from the frame from which the overhead is removed and then transmits the client signals outside the device.

In this instance, the frame counter unit 13B writes phase information n, which indicates a position within a transmission frame from the OTU2 OH generation unit 12D, to the DM byte using reception of the DM byte in which the flag bit is set as a trigger, and then sends the DM byte to the OTU2 OH generation unit 12B. The OTU2 OH generation unit 12B adds the overhead including the DM byte to a frame from the client multiplexing/accommodation unit 11B, and then returns an OTU2 frame serving as a second frame to the OTN optical transmission device 1A.

Finally, in FIG. 4, the delay measurement unit 16 of the OTN optical transmission device 1A. extracts the phase information n from a DM byte that is returned from the OTN optical transmission device 1B and is terminated by the OTU2 OH termination unit 14A and calculates the RTT by subtracting the phase shift between the reception frame and the transmission frame within the OTN optical transmission device 1B. That is, the frame counter unit 13A stops the counter simultaneously with receiving the DM byte in which the flag bit is set, and the delay measurement unit 15 calculates the frame phase, the length of which is less than one frame, by subtracting the phase information n stored in the DM byte from the value of the counter. The client separation unit 15A separates the client signals from the frame from which the overhead is removed and then transmits the client signals outside the device.

Next, a description will be given of the procedure of a delay measurement method in the first embodiment. FIG. 5 is an explanatory diagram describing the optical transmission system according to the first embodiment of the present invention. In the respective figures, the same reference numeral indicates the same or a corresponding part. In FIG. 5, the vertical axis corresponds to a time t, and transmission and reception of an OTU2 frame between the OTN optical transmission device 1A and the OTN optical transmission device 1B is indicated in time series.

For example, in the example illustrated in FIG. 5, the OTN optical transmission device 1B receives a DM byte including a flag bit at the 10,000^{th} byte of an OTU2 frame in a transmission frame phase (a) and at the 2,000^{th} byte in a transmission frame phase (b). Although the RTT is actually the same in any of the transmission frame phases (a) and (b), a measurement error is generated due to the difference in the transmission frame position at a time t2 at which a DM byte is received in the conventional delay measurement method as described above. In this regard, with reference here to the transmission frame position at the time t2 at which the DM byte is received, the frame counter unit 13B inserts the phase information n indicating the transmission frame position into the DM byte.

For example, in FIG. 5, the OTN optical transmission device 1B receives a DM byte transmitted at a time t0 from the OTN optical transmission device 1A at the time t2. However, it is unclear whether the DM byte is transmitted at a time t3(a) or a time t3(b) depending on the transmission frame phases (a) and (b). Herein, in the transmission frame phase (a), the OTN optical transmission device 1B transmits the 10,000^{th} byte from the head of the OTU2 frame at the time t2. Therefore, the OTN optical transmission device 1B transmits the DM byte at the time t3(a), and then reports 10,000 or the value of (one frame length −10,000) with the DM byte.

The OTN optical transmission device 1A receives the DM byte, calculates a time t1(a)-t0 taken from the time t0 (counter start) at which the OTN optical transmission device 1A transmits the DM byte until a time t1(a) (counter stop) at which the OTN optical transmission device 1A receives the DM byte, and then subtracts a time corresponding to (one frame length-10,000) bytes from the time t1(a)-t0, thereby correcting for the time difference from the time t2 at which the OTN optical transmission device 1B receives the DM byte until the time t3(a) at which the OTN optical transmission device 1B transmits the DM byte.

In this way, when measurement is conducted in units of byte at 10 Gb/s, the delay measurement accuracy can be improved to 0.8 nsec. When measurement is conducted in units of bit, the delay measurement accuracy can be improved to 100 psec. That is, the RTT may be measured in units of time sufficiently shorter than 12 usec, which is one frame length of an OTU2 frame. Further, the RTT can be measured with sufficient measurement accuracy in units of time shorter than +/−16 ns, which is the accuracy of the RTT defined in the above-described CPRI signal.

Similarly, when the DM byte is received in the transmission frame phase (b), the time difference from the time t2 at which the DM byte is received by the OTN optical transmission device 1B until the time t3(b) at which the DM byte is transmitted by the OTN optical transmission device 1B can be corrected for by reporting 2,000 or the value of (one frame length-2,000) with the DM byte. Therefore, it is possible to obtain the same RTT value as that in the transmission frame phase (a) without a measurement error being generated.

As described in the foregoing, in the optical transmission system according to the first embodiment of the present invention, the frame counter unit 13B of the return-side OTN optical transmission device 1B inserts the phase information n indicating the transmission frame position at the time t2 at which the DM byte in which the flag bit is set is received into the DM byte, and the delay measurement unit 15 of the delay measurement-side OTN optical transmission device 1A uses the phase information n from the DM byte to calculate the RTT by subtracting the phase shift between the reception frame and the transmission frame within the OTN optical transmission device 1B. In this way, in the optical transmission system using the OTUk frame, there is an effect where delay measurement with the measurement accuracy less than the length of the OTUk frame can be achieved by using a DM byte.

In the optical transmission system according to the first embodiment of the present invention, the frame counter unit 13B of the return-side OTN optical transmission device 1B may divide phase information indicating the transmission frame position at the time t2 at which the DM byte in which the flag bit is set is received and insert them into a plurality of DM bytes of a plurality of OTUk frames transmitted thereafter, and the delay measurement unit 15 of the delay measurement-side OTN optical transmission device 1A may use the phase information from the DM bytes to calculate the RTT by subtracting the phase shift between the reception frame and the transmission frame within the OTN optical transmission device 1B. In this way, even when the amount of information storable in one DM byte is restricted, for example, highly accurate phase information in bits can be divided and stored in a plurality of DM bytes; therefore, an effect can be obtained where the RTT can be measured with higher measurement accuracy.

In addition, the optical transmission system according to the first embodiment of the present invention is riot limited to the transfer rates being 10 Gb/s and 2.5 Gb/s, the wavelength range of the optical signal being 1.5 um, and an optical fiber transmission line being used. For example, the transfer rates may be 100 Gb/s and 40 Gb/s, the wavelength range of an optical signal may be 1.3 um, and the optical space transmission line may be used. Even is such a case, a similar effect can be obtained.

Further, even though the optical transmission system according to the first embodiment of the present invention is suitable for application to MFH, the OTUk frame, the DM byte, and the CPRI signal are not limited thereto. In other words, the OTUk frame, the DM byte, and the CPRI signal are not limited to being applied to an optical transmission system for transmitting an optical signal, and a similar effect can be obtained by using any frame, delay measurement control signal, and user data as long as the frame, the delay measurement control signal, and the user data are applied to a system in which it is desired to measure the transmission delay time in units of time shorter than one frame length or the accuracy defined for the user data

### Reference Signs List

1A, 1B OTN optical transmission device, 2 optical fiber transmission line, 3 BBU (Base Band Unit), 4 RRH (Remote Radio Head), 11A, 11B client multiplexing/accommodation unit, 12A, 12B OTU2 OH generation unit, 13A, 13B frame counter unit, 14A, 14B OTU2 OH termination unit, 15A, 15B client separation unit, 16 delay measurement unit.

1. An optical transmission system comprising:
a first optical transmission device that transmits a first frame including a control signal; and
a second optical transmission device that receives the first frame, inserts, into a control signal, phase information indicating a transmission position within a frame transmitted at a time at which the control signal of the first frame is received, and transmits a second frame including the control signal into which the phase information is inserted, wherein
the first optical transmission device receives the second frame and measures a transmission delay time between the first optical transmission device and the second optical transmission device on a basis of information indicating a time at which the control signal of the first frame is transmitted, information indicating a time at which the control signal of the second frame is received, and the phase information.

2. The optical transmission system according to claim 1, wherein the first optical transmission device obtains a time difference between the time at which the control signal of the first frame is received and a time at which the control signal of the second frame is transmitted on a basis of the phase information and measures a transmission delay time on a basis of the obtained time difference.

3. The optical transmission system according to claim 1, wherein the second optical transmission device divides the phase information and inserts the phase information into a control signal of a plurality of frames transmitted after the second frame.

4. The optical transmission system according to claim 1, wherein
a frame is an Optical channel Transport Unit-k (OTUk) frame,
a control signal corresponds to a Delay Measurement (DM) byte, and
the first optical transmission device measures a transmission delay time in units of time shorter than one frame length of the OTUk frame.

5. The optical transmission system according to claim 4, wherein
a frame includes a Common Public Radio Interface (CPRI) signal serving as payload data of an OTUk frame, and
the first optical transmission device measures a transmission delay time in units of time shorter than an accuracy of a transmission delay time defined in the CPRI signal.

6. A delay measurement method comprising:
a first step of a first optical transmission device transmitting a first frame including a control signal;
a second step of a second optical transmission device receiving the first frame transmitted in the first step;
a third step of the second optical transmission device inserting, into a control signal, phase information indicating a transmission position within a frame transmitted at a time at which the control signal of the first frame is received in the second step;
a fourth step of the second optical transmission device transmitting a second frame including the control signal into which the phase information is inserted in the third step;
a fifth step of the first optical transmission device receiving the second frame transmitted in the fourth step; and
a sixth step of the first optical transmission device measuring a transmission delay time between the first optical transmission device and the second optical transmission device on a basis of information indicating a time at which the control signal of the first frame is transmitted in the first step, information indicating a time at which the control signal of the second frame is received in the fifth step, and the phase information.
